(19) United States
(12) Patent Application Publication
(10) Pub. No.: US 2008/0038448 A1
(43) Pub. Date: Feb. 14, 2008

(54) Chemical resistant semiconductor processing chamber bodies

(75) Inventors: Arnold Kholodenko, San Francisco, CA (US); Wing Cheng, Sunnyvale, CA (US); Helen Cheng, Sunnyvale, CA (US); Mark Mardelboym, Santa Clara, CA (US); Grant Peng, Fremont, CA (US); Katrina Mikhaylichenko, San Jose, CA (US)

Correspondence Address: MARTINE PENILLA & GENCARELLA, LLP, 710 LAKEWAY DRIVE, SUITE 200, SUNNYVALE, CA, 94085, US

(73) Assignee: LAM RESEARCH CORP., Fremont, CA (US)

(21) Appl. No.: 11/731,075

(22) Filed: Mar. 30, 2007

Related U.S. Application Data
(60) Provisional application No. 60/822,228, filed on Aug. 11, 2006.

(51) Int. Cl. B05C 11/00; B05D 3/00

(52) U.S. Cl. 427/97.6; 118/501; 118/73; 427/299

(57) ABSTRACT

In one embodiment a chamber body enabling semiconductor processing equipment to be at least partially housed in the chamber body, the semiconductor processing equipment being configured to process a substrate using fluids is disclosed. The chamber body being comprised of a base material implemented to form the chamber body, the chamber body defined by at least a bottom surface and wall surfaces that are integrally connected to the bottom surface to enable capture of overflows of fluids during the processing of the substrate over the chamber body. Additionally, the base material is metallic. The chamber body also has a primer coat material disposed over and on the base material. The primer coat material has metallic constituents to define an integrated bond with the base material along with non-metallic constituents. The chamber body further includes a main coat material disposed over and on the primer coat material. The main coat material being defined from non-metallic constituents, the non-metallic constituents of the main coat material defining an integrated bond with the primer coat material. The main coat material defined to completely overlie all the metallic constituents of the primer coat.

### CLAIM OF PRIORITY

The present application claims priority from U.S. Provisional Application No. 60/822,228, filed on Aug. 11, 2006, which is herein incorporated by reference.

### BACKGROUND OF THE INVENTION

1. Field of the Invention

The present invention relates generally to the semiconductor processing equipment, and more particularly, containment of semiconductor processing fluid and reducing potential sources of contamination from processing fluid interaction with the processing equipment.

2. Description of the Related Arts

In the field of semiconductor processing, processing equipment can expose substrates to a variety of processing fluids that are highly reactive. The reactive nature of the processing fluids can result in contamination of the substrate and decreased yields. To contain the processing fluids, processing equipment using the processing fluids can be positioned within a chamber body fabricated from non-reactive plastics. The use of non-reactive plastics provides a chamber body that can minimize a source of contamination should the chamber body is exposed to the processing fluids. While plastics can reduce possible sources of contamination, a chamber body fabricated using plastics may not be as robust as a chamber body fabricated using metals. However, using a metallic chamber body may increase the likelihood of contaminating the substrate if the metallic chamber body is exposed to the processing fluids. In view of the forgoing, there is a need for a robust, non-reactive chamber body.

### SUMMARY

In one embodiment a chamber body enabling semiconductor processing equipment to be at least partially housed in the chamber body, the semiconductor processing equipment being configured to process a substrate using fluids is disclosed. The chamber body being comprised of a base material implemented to form the chamber body, the chamber body defined by at least a bottom surface and wall surfaces that are integrally connected to the bottom surface to enable capture of overflows of fluids during the processing of the substrate over the chamber body. Additionally, the base material is metallic. The chamber body also has a primer coat material disposed over and on the base material. The primer coat material has metallic constituents to define an integrated bond with the base material along with non-metallic constituents. The chamber body further includes a main coat material disposed over and on the primer coat material. The main coat material being defined from non-metallic constituents, the non-metallic constituents of the main coat material defining an integrated bond with the primer coat material. The main coat material defined to completely overlie all the metallic constituents of the primer coat.

In another embodiment a method for manufacturing a chamber body for at least partially containing semiconductor processing equipment and capturing any excess fluids as a result of processing a substrate is disclosed. The method begins by forming the chamber body from a base material. The chamber body has at least a bottom surface and wall surfaces that are integrally connected to the bottom surface. The bottom and wall surfaces enable capture of overflows of fluids during the processing of the substrate over the chamber body and the base material is metallic. The method continues by preparing the chamber body for a primer coat material in order to promote a stable bonding surface for the primer coat material. Next, the primer coat material is applied over and on the base material. The primer coat material having non-metallic constituents and metallic constituents capable of forming a bond with the base material. The next step is curing the primer coat material to a dimensionally stable hardness which is followed by preparing the chamber body for a main coat material in order to promote a stable bonding surface for the main coat material. The method continues by applying the main coat material over and on the primer coat material. The main coat material defined from non-metallic constituents, the non-metallic constituents of the main coat forming an integrated bond with the primer coat material and completely covering the primer coat. The method is finalized by curing the main coat material to a dimensionally stable hardness, wherein the cured main coat material isolates the metallic constituents of the primer coat from reacting with elements of the captured overflow of fluids.

In yet another embodiment a device for processing semiconductor substrates using process fluids is disclosed. The device is comprised of an enclosure which defines a processing semiconductor processing unit that includes a frame system and a chamber body coupled to the frame system. The chamber body has a base material implemented to form the chamber body. The chamber body being defined by at least a bottom surface and wall surfaces that are integrally connected to the bottom surface. The bottom surface and wall surfaces enable capture of overflows of fluids during the processing of the substrate over the chamber body and the base material is metallic. The chamber body also has a primer coat material disposed over and on the base material. The primer coat material having metallic constituents to define an integrated bond with the base material and non-metallic constituents. The chamber body also has a main coat disposed over and on the primer coat material. The main coat material defined from non-metallic constituents, the non-metallic constituents defining an integrated bond with the primer coat material and the main coat completely overlying all the metallic constituents of the primer coat. The device for processing semiconductor substrates also includes semiconductor processing equipment at least partially housed in the chamber body and a system which controls the environment within the enclosure. The device for processing semiconductor substrates also includes a system that stores and supplies process fluids to the semiconductor processing equipment and a system that controls and monitors the semiconductor processing equipment.

### BRIEF DESCRIPTION OF THE DRAWINGS

The invention, together with further advantages thereof, may best be understood by reference to the following description taken in conjunction with the accompanying drawings.

FIG. 1 is a simplified diagram of a high level overview of a system for processing semiconductor substrates in accordance with one embodiment of the present invention.

FIG. 2 is a simplified diagram of a cross section of semiconductor process within the chamber body in accordance with one embodiment of the present invention.

FIG. 3 is a simplified diagram of a cross section of a spin drying semiconductor process within the chamber body in accordance with one embodiment of the present invention.

FIG. 4 is a diagram of a cross-section of a substantially chemically inert chamber body showing different layers of material used to coat the chamber body in accordance with one embodiment of the present invention.

FIG. 5 is a flow chart illustrating the procedure of creating a chamber body in accordance with one embodiment of the present invention.

FIG. 6 is a flow chart illustrating the procedure to coat the chamber body in accordance with one embodiment of the present invention.

FIG. 7 is a flow chart illustrating the procedure to process a chamber body in accordance with one embodiment of the present invention.

FIG. 8A is a schematic illustrating a chamber body in accordance with one embodiment of the present invention.

FIG. 8B is a schematic illustrating a proximity head and substrate carrier installed in a chamber body in accordance with one embodiment of the present invention.

FIG. 9 is a schematic illustrating a semiconductor processing unit with a chamber body, in accordance with one embodiment of the present invention.

FIGS. 10A and 10B are different views of modular chamber body components in accordance with one embodiment of the present invention.

FIGS. 11A-11D are various cross-section views of an interface between chamber body components in accordance with embodiments of the present invention.

### DETAILED DESCRIPTION

An invention is described for improving the chemical resistance of a chamber body for use during semi-conductor substrate processing. The embodiments of the present invention enable a chamber body to be made of any size, and specifically, larger than single substrate chambers, without compromising the structural integrity and resistivity to chemicals designed for use in the chamber. Today's feature sizes, which continue to shrink into the nanometer range and smaller, require the minimization of potential sources of contamination. Wafer processes utilizing highly reactive chemicals such as hydrofluoric acid (referred to as HF) are conducted in chamber bodies composed of materials that do not produce detrimental contamination when exposed to HF. For example, forming a chamber body from plastics such as polyvinylchloride (PVC) and polytetrafluoroethylene (PTFE) reduces the possibility of contamination because the materials are non-reactive in the presence of HF. However, forming large chamber bodies from plastics can be expensive, difficult and not necessarily geometrically nor statically stable enough to accommodate the precision tolerances required in semiconductor processing. The use of non-plastics such as metals, ceramics, and composite materials for the chamber body can alleviate the geometric and stability problems that can be associated with large plastic chamber bodies. However, HF and other reactive chemicals can react with a metallic chamber body and result in detrimental contamination of the wafer.

As will be discussed below, a coating of HF resistant material on top of a non-plastic chamber body can alleviate the potential of the non-plastic chamber to detrimentally contaminate the wafer. A non-plastic chamber body with a HF resistant coating can be used for single-wafer wet clean processes. These single-wafer wet clean processes can have several stages, and thus, the chamber body may be relatively large. It will be obvious to one skilled in the art that the present invention may be practiced without some, or all, of these specific details. In other instances, well known process operations have not been described in detail in order not to unnecessarily obscure the present invention.

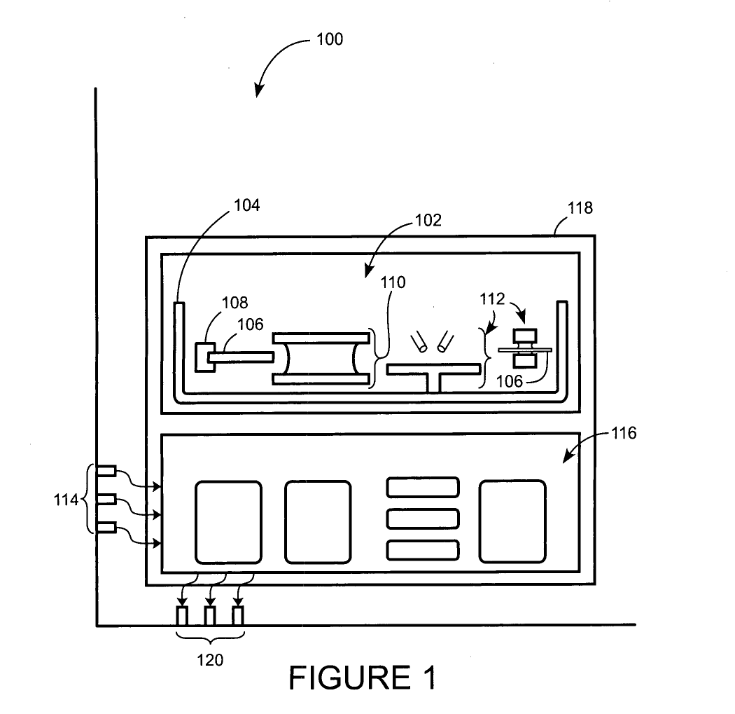

FIG. 1 is a simplified diagram of a high level overview of a system for processing semiconductor substrates in accordance with one embodiment of the present invention. As shown in FIG. 1, a clean room 100 houses a semiconductor processing unit 118. The semiconductor processing unit 118 contains a processing chamber 102 and an ancillary chamber 116. The processing chamber 102 includes a chamber body 104 that is used to contain semiconductor processes such as, but not limited to, plating 110 and wet cleaning 112. As shown, the wet clean can be of different forms. For instance, a spin-type system may be used or a proximity head system that uses a fluid meniscus may be used. Within the chamber body 104 a wafer carrier 108 can transport a wafer 106 so the semiconductor processes can be performed on the wafer 106.

The clean room 100 can have input lines 114 that supply power and processing fluids. The clean room 100 can also have output lines 120 that allow for the removal of used processing fluids from the semiconductor processing unit 118. Some of the input lines 114 can provide computer-networking capacity allowing the semiconductor processing unit 118 to be monitored and controlled from a remote location. Other input lines 114 may supply processing fluid to a storage tank within the ancillary chamber 116. The output lines 120 can facilitate the removal of used processing fluid from a storage tank within the ancillary chamber 116.

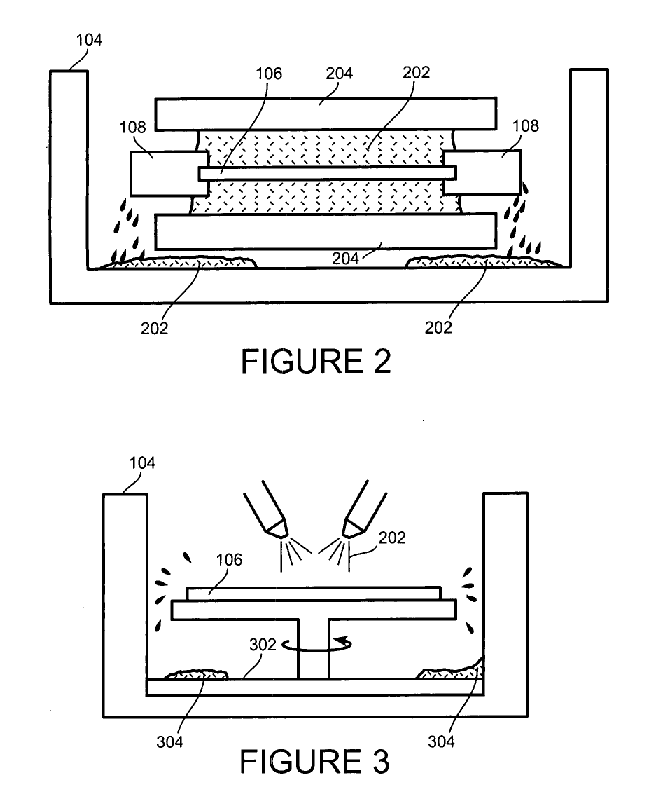

FIG. 2 is a simplified diagram of a cross section of semiconductor process 102 within the chamber body 104 in accordance with one embodiment of the present invention. In one embodiment, the wafer 106 is passing through a meniscus of a process fluid 202 maintained between heads 204. The heads 204 can be used to plate a metallic layer, such as copper or other metals, or the heads 204 can be used to apply and remove fluids to define controlled fluid menisci (shown as fluid 202). In another embodiment the process fluid 202 is sprayed directly onto the wafer 106. To ensure the process fluid 202 covers the maximum area of the wafer 106 the process fluid 202 is allowed to contact the wafer carrier 108. As the process fluid 202 flows onto and around the wafer carrier 108 it is possible that some of the process fluid 202 can drip or flow off the wafer carrier 108 and onto the chamber body 104.

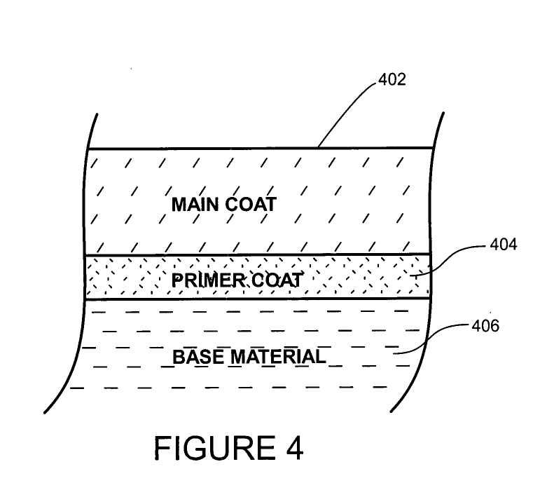

FIG. 3 is a simplified diagram of a cross section of a spin drying semiconductor process 102 within the chamber body 104 in accordance with one embodiment of the present invention. In this embodiment the wafer 106 is secured to a device 110 that can rotate at a high enough speed so fluid is removed from the surface of the wafer 102 by centrifugal force. Various process fluids 202 can be introduced to the surface of the wafer 106 and subsequently the wafer is spun dry. Spin drying the wafer allows the process fluids 202 to contact the chamber body 104 and can allow pools 304 of the process fluids 202 to form on the interior surface 302 of the chamber body 104. These pools 304 can then flow out through appropriate exit holes or channels.

Process fluids 202 that can be used within the chamber body 104 found in FIG. 2 and FIG. 3 include highly reactive chemicals such as hydrofluoric acid, ozonated water, deionized water or mixtures with chemicals, isopropyl alcohol, ammonia, etc. The chemicals listed are exemplary and are not intended to limit the type of chemicals that can be used within the chamber body 104. Because a chamber body can be exposed to highly reactive chemicals and the semiconductor processes conducted in the chamber bodies are sensitive to contamination, a chamber body must be substantially chemically inert.

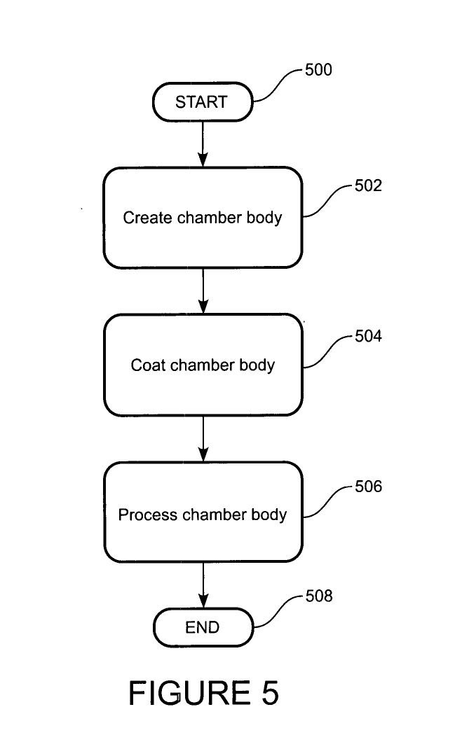

FIG. 4 is a diagram of a cross-section of a substantially chemically inert chamber body 104 showing different layers of material used to coat the chamber body 104 in accordance with one embodiment of the present invention. The base material 406 is the chamber body, and in one embodiment the base material 406 can be an aluminum alloy. In another embodiment the base material 406 can be a ferrous alloy. In yet another embodiment the base material 406 can be a titanium alloy. In another embodiment the base material 406 can be a composite material such as carbon fiber. In another embodiment the base material 406 can be a ceramic.

The primer coat 404 is applied over the base material 406. The primer coat 404 can contain metallic as well as non-metallic components and can be applied using a variety of techniques. In one embodiment the primer coat 404 can be a powder coating that is electrostatically sprayed onto the base material 406. In another embodiment the primer coat 404 can be painted on the base material 406. In yet another embodiment the base material can be dipped into a vat filled with the primer coat 404 material. After the application of the primer coat 404 the base material with the primer coat can be cured using any variety of techniques capable of varying temperature, pressure, and humidity. The application of multiple layers of primer coat 404 may be necessary to create a layer of sufficient thickness to protect the base material 406 and provide a stable bonding surface for the main coat 402. In one embodiment, the primer coat 404 is Composition 1 applied and cured as multiple layers of an electrostatic powder coating to a thickness of between about 0.005 inches and about 0.025 inches over a base material 406 of an aluminum alloy.

In one embodiment, Composition 1 can be a coating material obtained from Solvay Solexis, S.p.A. of Bollate, Italy, and Composition 1 can be Halar 9414. Halar 9414 was selected, as its performance in application to the chamber body was found to be of high quality. The constituents of particular usefulness include about 0.5% titanium, about 2.4% aluminum, about 1.3% silicon, about 40% carbon, about 0.6% chlorine, about 32% oxygen and about 23% fluorine. Note that Halar 9414 is only one example, and Composition 1 can be either mixed from base elements or obtained from other suppliers that can approximate the mixture of the constituents. In particular, it is believed that the constituents of Composition 1, find particular usefulness in defining good adhesion and integration with the metallic structure of the chamber body. As will be discussed below, Composition 1 was also selected so as to define a base for the following main coat 402.

The main coat 402 is therefore applied over the primer coat 404. In order to minimize the possibility of creating metallic contamination from a reaction between the main coat 402 and any chemicals used within the chamber body 104 the composition of the main coat 402 should minimize metallic content. The techniques used to apply and cure the main coat can be the same as those used to apply the primer coat 404. As with the primer coat 404, multiple applications of the main coat 402 may be required to achieve the desired thickness. In one embodiment the main coat 402 is Composition 2 applied and cured in multiple layers of an electrostatic powder coating to a thickness of 0.010-0.090 inches over the primer coat 404 of Composition 1. In one embodiment, Composition 2 can be coating material obtained from Solvay Solexis, S.p.A. of Bollate, Italy, and Composition 2 can be Halar 6014F. Halar 6014F was selected, as its performance in application to the chamber body was found to be of high quality. The constituents of particular usefulness include about 65% carbon, about 4.4% chlorine, and about 30% fluorine. It is noted that Halar 6014F is only one example, and Composition 2 can be either mixed from base elements or obtained from other suppliers that can approximate the mixture of the constituents. In particular, it is believed that the constituents of Composition 2, find particular usefulness in not producing detrimental contamination when exposed to the process chemicals 202. As will be discussed below, Composition 2 was also selected because of its clear color and machinable qualities when fully cured.

One of the many advantages of using the combination of Composition 1 as the primer coat 404 and Composition 2 as the main coat 402 is that the final color of the chamber body 104 conforms to industry tradition. Traditionally, chamber bodies have been constructed from plastics such as PVC or PTFE that have a whitish or yellowish color. When fully cured the primer coat 404 of Composition 1 is a whitish color while the main coat 402 of cured Composition 2 is substantially clear. Therefore, application of Composition 1 over Composition 2 to a chamber body results in a chamber body with a whitish color. Because users of semiconductor processing equipment have become accustomed to the whitish or yellowish color of chamber bodies the use of Composition 1 and Composition 2 provides users with a familiar color.

The precision and accuracy required to maximize output from modern semiconductor processing equipment requires exacting tolerances. Multiple reference data surfaces that are part of a chamber body 104 can minimize process variations by locating process equipment in definite areas. The over application of the primer coat 404 and the main coat 402 can require the removal of excess material from a reference data surface. One of the many advantages of using Composition 2 as the main coat 402 is ability to machine Composition 2 after the final coating is cured without adversely affecting chemical resistance of the Composition 2. Thus, if a reference data surface has an excessive amount of main coating a mill or other type of process can be used to remove the excess material and bring the reference data surface back within specified tolerances.

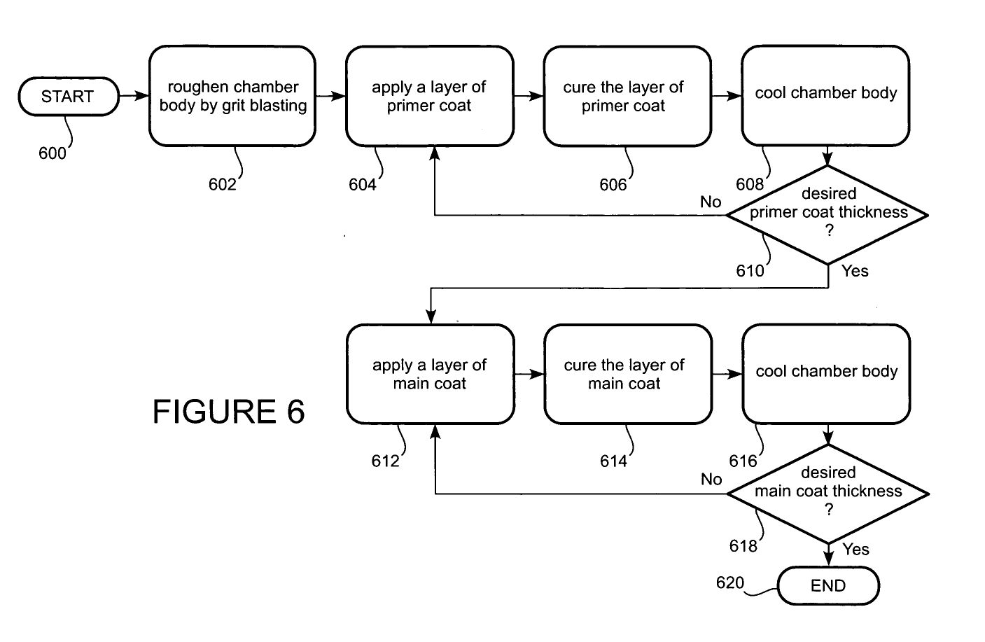

FIG. 5 is a flow chart illustrating the procedure of creating a chamber body in accordance with one embodiment of the present invention. The process starts with operation 500 and is followed by operation 502 where the chamber body is created from a base material. A chamber body created from a metal alloy can be formed using machining and joint processes such as milling, drilling, welding and bonding. A ceramic chamber body can be created using sintering, injection molding or another ceramic forming process. The formation of the chamber body is not limited to the types of materials and processes listed above.

After the chamber body is formed, execution of operation 504 coats the chamber body. As discussed above, coating the chamber body can be done with a primer coat and a main coat. Multiple applications of coatings may be required to achieve the desired thickness of the respective coatings. Additionally, it is possible that one or both of the primer coat and main coat may be composed of non-homogenous layers of various coatings.

Upon completion of operation 504, operation 506 processes the coated chamber body. Processing the chamber body is intended to identify uneven application of the coatings to the chamber body. Processing the chamber body can also include removing uneven applications of the coating that are found to compromise the dimensional tolerances of the chamber body. Once the chamber body has been processed, the procedure is completed with operation 508.

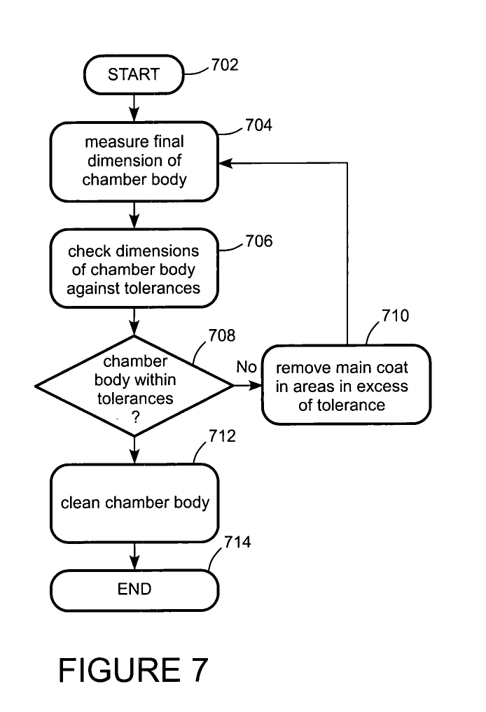

FIG. 6 is a flow chart illustrating the procedure to coat the chamber body in accordance with one embodiment of the present invention. The process starts with operation 600 and proceeds to operation 602 where the exterior surface of the base material is subjected to an abrading process such as grit blasting or sanding. The abrading process may facilitate the adhesion of the coatings to a metallic surface by roughening the surface and providing more adhesion surface area for the coating. In one embodiment the material used to abrade the chamber body is aluminum oxide. If the chamber body is composed of a ceramic or composite material abrading the chamber body may not be necessary depending on the surface finish of the chamber body. After being abraded, operation 604 applies a layer of primer coat. The process continues with operation 606 where the primer coat is cured to a dimensionally stable hardness and operation 608 where the chamber body is allowed to cool. One skilled in the art should recognize that operation 608 might not be necessary if operation 606 is conducted at room temperature. Operation 610 is used to check if the primer coat has reached the desired thickness. If the primer coat has not reached the desired thickness the procedure returns to execute operation 604 through operation 610. Note that before additional layers of the primer coat are added, the chamber body may be abraded to improve adhesion of a next layer of primer coat. Once the primer coat has reached the desired thickness, the procedure advances to operation 612.

Operation 612 applies a layer of the main coat followed by operation 614 that cures the main coat to a dimensionally stable hardness. Operation 616 allows the chamber body to cool after going through the curing operation. Note that operation 616 may not be necessary depending on the conditions required to cure the main coat. Operation 618 checks if the main coat is at the desired thickness. If the chamber body requires additional main coating the procedure execute operation 612 through 618. Similar to the primer coat, before additional lawyers of the main coat are added, the chamber body may be abraded to improve adhesion of a next layer of main coat. Once the main coat has reached the desired thickness, the procedure is completed at operation 620.

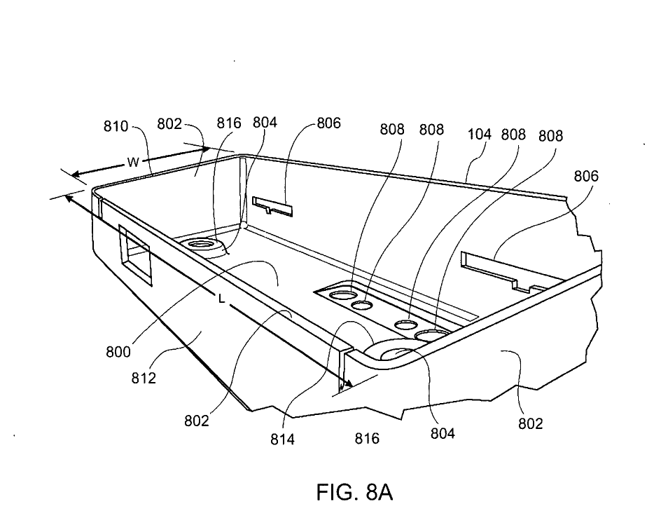

FIG. 7 is a flow chart illustrating the procedure to process a chamber body in accordance with one embodiment of the present invention. The operation begins with operation 702 and advances to operation 704 where measurements are taken of the final dimensions of the chamber body. The measurements can include layer thicknesses in specific areas acquired using ultrasonic measuring techniques and other critical dimension acquired using a variety of measuring techniques. Execution of operation 706 verifies that the dimensions acquired in operation 704 are with specified dimensions and tolerances. If the chamber body dimensions are not within the specified tolerances operation 708 advances the procedure to operation 710 where main coating is removed in areas in excess of the specified tolerance. If the chamber body dimensions are within the specified tolerances, operation 708 advances the procedure to operation 712 where the chamber body is cleaned. The procedure is completed with operation 714.

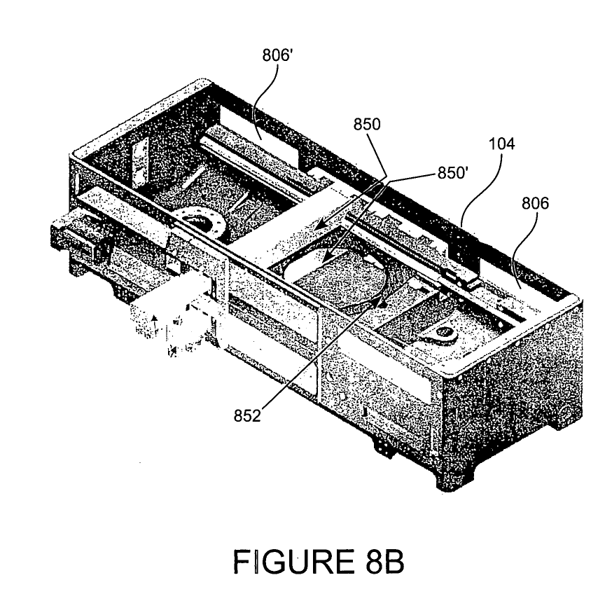

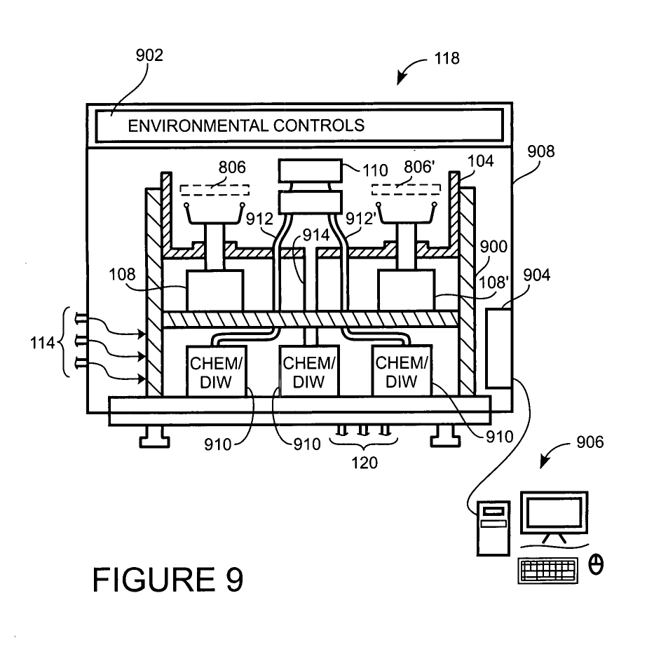

FIG. 8A is a schematic illustrating a chamber body 104 in accordance with one embodiment of the present invention. The chamber body 104 has a bottom surface 800 that is integrally connected with wall surfaces 802 that form an interior cavity. In one embodiment, the chamber has an overall width 810 of about 21 inches and an overall length 812 of about 60 inches. Note that the dimensions provided for the chamber body 104 are not intended to be limiting. In one embodiment the chamber body 104 can be fabricated by machining the chamber from a single billet of material. In another embodiment, modular chamber body component pieces can be assembled to form the chamber body 104.

As shown in FIG. 8A, there can be a variety of opening to the interior cavity of the chamber body 104 along with a variety of reference data surfaces. For example, ports 804 and 808 provide access to the interior cavity of the chamber body 104 via circular openings. Note that ports 804 are located on bosses 814 that include reference data surfaces 816. The reference data surfaces 816 can be used to locate and position semiconductor processing equipment within the chamber body 104. Port 806 and port 806′ provide access to the interior cavity of the chamber body 104 using rectangular opening. In one embodiment of the invention, a substrate enters the chamber body 104 by passing through port 806. The substrate can be processed by equipment at least partially within the chamber body 104 and passed out of the chamber body 104 through port 806′ when processing within the chamber body 104 is completed. The location and dimensions of port 806 and 806′ can also be considered reference data surfaces. Note that ports 808, shown in a recessed area of the interior cavity of the chamber body 104 can also be considered reference data surfaces.

FIG. 8B is a schematic illustrating a proximity head and substrate carrier 852 installed in a chamber body 104 in accordance with one embodiment of the present invention. The substrate carrier 852 is shown without a substrate in places permitting viewing of a bottom head 850′ of the proximity head. A top head 850 of the proximity head is located substantially above, and spaced away from the bottom head 850′, to allow the substrate carrier 852 to pass between the top head 850 and bottom head 850′. Ports 806 and 806′ allows substrates to be moved in and out of the chamber body.

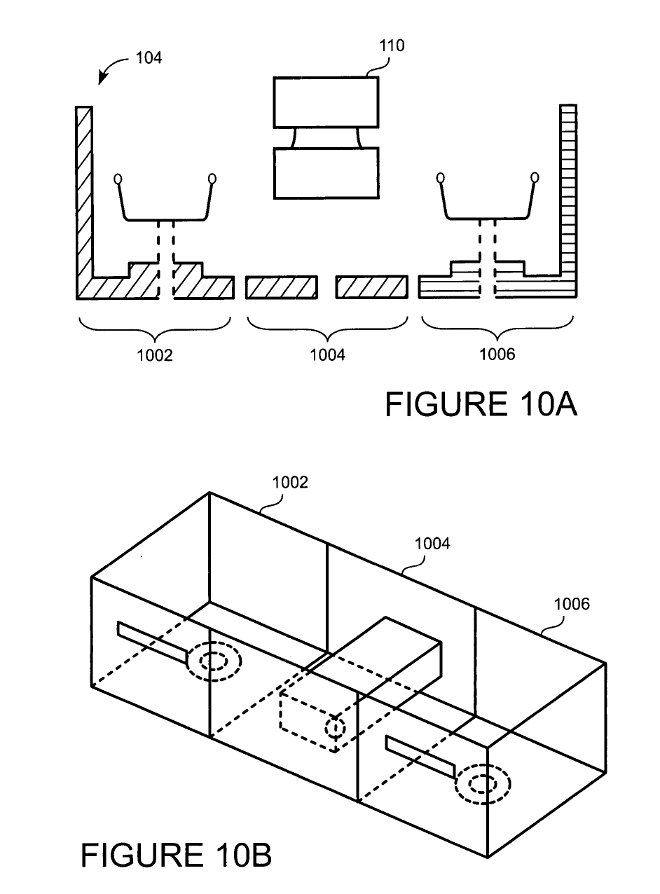

FIG. 9 is a schematic illustrating a semiconductor processing unit 118 with a chamber body 104, in accordance with one embodiment of the present invention. The semiconductor processing unit 118 can include environmental controls 902. The environmental controls 902 can include, but are not limited to, air filtration systems and temperature and humidity control. Input lines 114 can supply power and processing fluids while output lines can facilitate the removal of processing fluids from the semiconductor processing unit 118. Electronics backbone 904 associated with the semiconductor processing unit 118 can interface with a computer 906 and/or a computer network. The electronics backbone 904 enables control and monitoring of processes within the semiconductor processing unit 118 through the computer 906 or remotely via the computer network.

A frame 900 is located within an enclosure 908. The chamber body 104 can be coupled to the frame 900. In one embodiment, semiconductor processing equipment is attached to the frame 900 and the chamber body 104. In other embodiments, semiconductor processing equipment is attached to only the chamber body 104. Wafer carriers 108 and 108′ are one of the many types of semiconductor processing equipment that can be associated with the chamber body 104. The wafer carrier 108 can assist in moving a substrate into the chamber body via port 806. Similarly, wafer carrier 108′ can be used to move a substrate out of the chamber body via port 806′. A proximity head 110 for performing wet substrate processing can be associated with the chamber body 104. The proximity head 110 can perform a variety of wet processes including cleaning and plating of a substrate. Other embodiment can include multiple proximity heads or additional semiconductor processing equipment associated with the chamber body 104. The particular types of semiconductor processing equipment discussed are not intended to be limiting.

In one embodiment, fluids are supplied to the semiconductor processing equipment from vessels 910. The vessels 910 can be used to store and/or mix process fluids supplied from input lines 114. In one embodiment, supply lines 912 and 912′ can pass through ports in the chamber body 104 to transport process fluids from the vessels 910 to the proximity head 110. Additionally, drain line 914 can be connected to a port on the chamber body 104 to provide recovery of overflow fluid from the proximity head 110. In other embodiments, the proximity head 110 can be configured to recover and recycle process fluids that may require recycling lines to return process fluids to the vessels 910. In yet other embodiments utilizing more than one proximity head or additional semiconductor processing equipment, individual drains can be formed in the chamber body 104 to enable recycling of different process fluids.

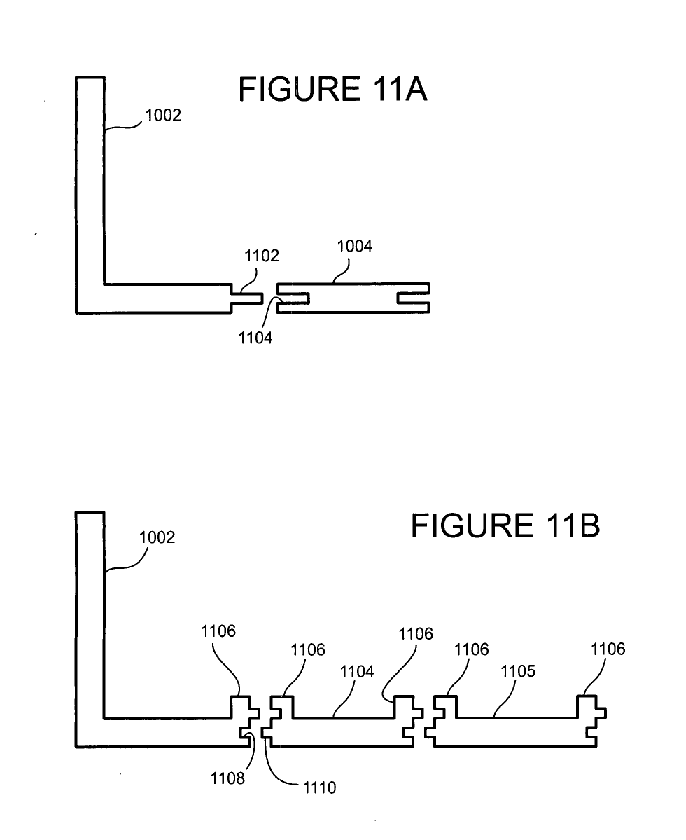

FIGS. 10A and 10B are different views of modular chamber body components 1002, 1003 and 1004 in accordance with one embodiment of the present invention. To provide flexibility to when processing substrates and simplify fabrication, assembly and installing of the chamber body, it may be advantageous to associate modular chamber body components with a particular piece of semiconductor processing equipment. As shown in FIG. 10A, chamber body component 1002 can be used as the left most component of the chamber body 104 while chamber body component 1006 can be used as the right most component. In each case, chamber body components 1002 and 1006 can be configured to accommodate a wafer carrier 108. Chamber body component 1004 can be configured to accommodate a variety of semiconductor processing equipment by including mounting surfaces that can be designed to meet a standard for ease of alignment, setup, installation, and sourcing.

In the embodiment illustrated in FIGS. 10A and 10B, a proximity head is shown associated with the chamber body component 1004. In order to accommodate the proximity head, or other semiconductor processing equipment, the chamber body component 1004 can allow for removable assemblies and piece parts. As the embodiments illustrated are intended to be exemplary and not intended to be restrictive, other embodiments of chamber body components can be configured with different removable assemblies and piece parts for different semiconductor processing equipment. Note that configuring the chamber body components for different semiconductor processing equipment can include adding or removing ports to accommodate input and output lines.

In one embodiment, chamber body components are formed and exposed to primer coat material and main coat material before being assembled into a completed chamber body. In another embodiment, chamber body components are formed and assembled into a completed chamber body before the application of primer coat and main coat materials. In yet other embodiments, as previously discussed, the chamber body is not formed from modular chamber body components, but rather from a single piece of base material.

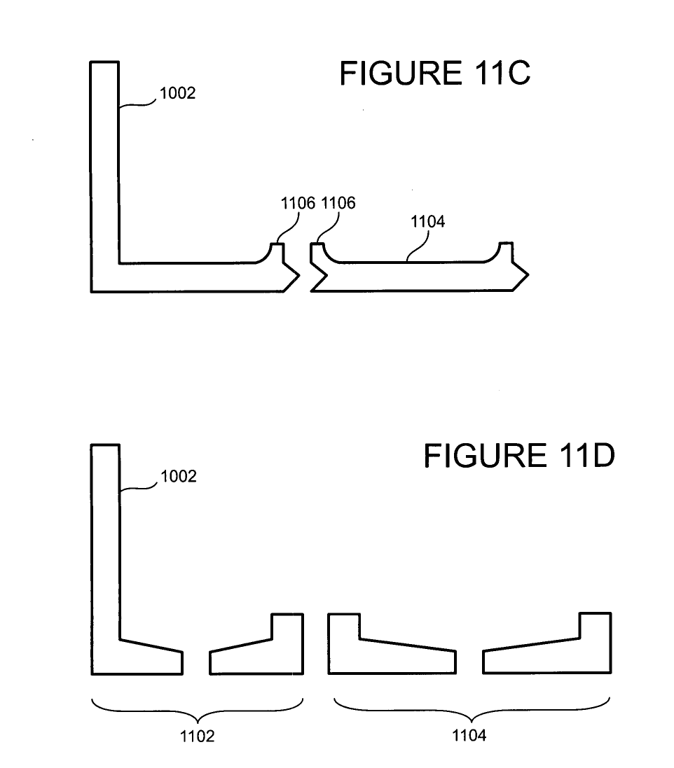

FIGS. 11A-11D are various cross-sectional views of an interface between chamber body components in accordance with embodiments of the present invention. As illustrated in FIG. 11A, chamber body component 1002 includes a tenon 1102 that can interface with a mortise 1104 of chamber body component 1004. In one embodiment, mortise 1104 and tenon 1102 features can be spaced at regular or irregular intervals along the interface between chamber body components 1002 and 1004. In another embodiment the mortise 1104 and tenon 1102 can extend along the interface between chamber body components 1002 and 1004.

The embodiment shown in FIG. 11B includes interlocking surfaces 1108 and 1110 and a fluid barrier 1106. As each chamber body component can be associated with a particular piece of semiconductor processing equipment, the use of fluid barriers 1106 can assist in recovering and recycling process fluids by preventing process fluids from mixing. For example, chamber body component 1004 could be located beneath a proximity head performing a plating operation while chamber body component 1105 could be located beneath a proximity head performing a cleaning operation. Fluid barriers 1106 can help prevent fluid from the plating operation from mixing with fluid from the cleaning operation and assist in recovery and recycling of the respective fluids. The embodiment illustrated in FIG. 11C uses a different style mortise 1104 and tenon 1102 in conjunction with a fluid barrier 1106. The embodiment illustrated in FIG. 11D shows forming the bottom of the chamber body components to promote draining of any recovered process fluid. The embodiments shown in FIG. 11A-11D are intended to be illustrative and not intended to be limiting. As previously discussed, chamber body components can include multiple ports for supply and drain lines. Furthermore, a chamber body can be composed of any number of chamber body components and associated semiconductor processing equipment.

Although a few embodiments of the present invention have been described in detail herein, it should be understood, by those of ordinary skill, that the present invention may be embodied in many other specific forms without departing from the spirit or scope of the invention. Therefore, the present examples and embodiments are to be considered as illustrative and not restrictive, and the invention is not to be limited to the details provided therein, but may be modified and practiced within the scope of the invention.

What is claimed is:

1. A chamber body enabling semiconductor processing equipment to be at least partially housed in the chamber body, the semiconductor processing equipment being configured to process a substrate using fluids, comprising:
a base material implemented to form the chamber body, the chamber body defined by at least a bottom surface and wall surfaces that are integrally connected to the bottom surface to enable capture of overflows of fluids during the processing of the substrate over the chamber body, the base material being metallic;
a primer coat material disposed over and on the base material, the primer coat material having metallic constituents to define an integrated bond with the base material and non-metallic constituents; and
a main coat material disposed over and on the primer coat material, the main coat material defined from non-metallic constituents, the non-metallic constituents of the main coat material defining an integrated bond with the primer coat material, the main coat material being defined to completely overlie all the metallic constituents of the primer coat.

2. The chamber body as recited in claim 1, wherein the main coat material isolates the metallic constituents of the primer coat and the metallic base material from reacting with elements of the captured overflow of fluids.

3. The chamber body as recited in claim 2, wherein the isolation is defined by an inert plastic characteristic of the main coat material.

4. The chamber body as recited in claim 1, wherein the main coat material has a hardness factor of between about 90 (Rockwell R) or 75 (Shore D).

5. The chamber body as recited in claim 4, wherein the hardness factor provides a machineable surface of the main coat material.

6. The chamber body as recited in claim 1, wherein the primer coat contains constituents that include titanium, aluminum, silicon, carbon, chlorine, oxygen and fluorine.

7. The chamber body as recited in claim 1, wherein the main coat contains constituents that include carbon, chlorine, and fluorine.

8. The chamber body as recited in claim 1, wherein the chamber body has a length of about 60 inches and a width of about 21 inches.

9. The chamber body as recited in claim 1, wherein the chamber body is an assembly of a plurality of chamber body components.

10. A method for manufacturing a chamber body for at least partially containing semiconductor processing equipment and capturing any excess fluids as a result of processing a substrate, comprising:
(a) forming the chamber body from a base material, the chamber body having at least a bottom surface and wall surfaces that are integrally connected to the bottom surface to enable capture of overflows of fluids during the processing of the substrate over the chamber body, the base material being metallic;
(b) preparing the chamber body for a primer coat material in order to promote a stable bonding surface for the primer coat material;
(c) applying the primer coat material over and on the base material, the primer coat material having non-metallic constituents and metallic constituents capable of forming a bond with the base material;
(d) curing the primer coat material to a dimensionally stable hardness;
(e) preparing the chamber body for a main coat material in order to promote a stable bonding surface for the main coat material;
(f) applying the main coat material over and on the primer coat material the main coat material defined from non-metallic constituents, the non-metallic constituents of the main coat forming an integrated bond with the primer coat material, the main coat material completely covering the primer coat, and
(g) curing the main coat material to a dimensionally stable hardness,
wherein the cured main coat material isolates the metallic constituents of the primer coat from reacting with elements of the captured overflow of fluids.

11. The method for manufacturing a chamber body as recited in claim 10, wherein the isolation is defined by an inert plastic characteristic of the main coat material.

12. The method for manufacturing a chamber body as recited in claim 10, wherein the main coat material is cured to a hardness factor of about 90 (Rockwell R) or 75 (shore D).

13. The method for manufacturing a chamber body as recited in claim 10, further comprising the step of:
removing excess main coat material from reference data surfaces of the chamber body to enable installation of semiconductor substrate processing equipment within proper tolerances, wherein the removal of excess main coat material does not affect chemical resistance of the main coat material.

14. The method for manufacturing a chamber body as recited in claim 10, wherein preparing the chamber body for a primer coat material includes abrading and cleaning the chamber body.

15. The method for manufacturing a chamber body as recited in claim 10, wherein preparing the chamber body for a main coat material includes abrading and cleaning the chamber body.

16. The method for manufacturing a chamber body as recited in claim 10, wherein the primer coat contains constituents that include titanium, aluminum, silicon, carbon, chlorine, oxygen and fluorine.

17. The method for manufacturing a chamber body as recited in claim 10, wherein the primer coat contains constituents that include titanium, aluminum, silicon, carbon, chlorine, oxygen and fluorine.

18. The method for manufacturing a chamber body as recited in claim 10, wherein the chamber body is formed from a plurality of modular chamber body components.

19. A device for processing semiconductor substrates using process fluids comprising:
an enclosure which defines a processing semiconductor processing unit including;
a frame system;
a chamber body coupled to the frame system defined by;
a base material implemented to form the chamber body, the chamber body defined by at least a bottom surface and wall surfaces that are integrally connected to the bottom surface to enable capture of overflows of fluids during the processing of the substrate over the chamber body, the base material being metallic;
a primer coat material disposed over and on the base material, the primer coat material having metallic constituents to define an integrated bond with the base material and non-metallic constituents; and
a main coat material disposed over and on the primer coat material, the main coat material defined from non-metallic constituents, the non-metallic constituents of the main coat material defining an integrated bond with the primer coat material, the main coat material being defined to completely overlie all the metallic constituents of the primer coat; semiconductor processing equipment at least partially housed in the chamber body;
a system for controlling the environment within the enclosure;
a system for controlling and supplying process fluids to the semiconductor processing equipment; and
a system for controlling and monitoring the semiconductor processing equipment.

20. A device for processing semiconductor substrates as recited in claim 19, wherein the main coat material isolates the metallic constituents of the primer coat and the metallic base material from reacting with elements of the captured overflow of fluids.

21. A device for processing semiconductor substrates as recited in claim 19, wherein the chamber body is an assembly of a plurality of chamber body components.
